(19) United States
(12) Patent Application Publication
(10) Pub. No.: US 2025/0141669 A1
(43) Pub. Date: May 1, 2025

(54) ENCRYPTION DEVICE, OPTIMIZATION SYSTEM, ENCRYPTION METHOD, AND ENCRYPTION PROGRAM

(71) Applicant: NEC Corporation, Tokyo (JP)

(72) Inventor: Akihiro YATABE, Tokyo (JP)

(73) Assignee: NEC Corporation, Tokyo (JP)

(21) Appl. No.: 18/909,018

(22) Filed: Oct. 8, 2024

(30) Foreign Application Priority Data
Nov. 1, 2023 (JP) 2023-187753

(51) Int. Cl. H04L 9/08

(52) U.S. Cl. CPC H04L 9/0852

(57) ABSTRACT

The model input means receives input of a model represented by a Hamiltonian. The model rewriting means generates a rewritten model by rewriting one variable selected from variables included in the model into multiple dummy variables subject to a same value constraint. The model rewriting means generates the rewritten model such that sum of coefficients of the dummy variables equals a coefficient of the one variable.

### CROSS-REFERENCE TO RELATED APPLICATIONS

This application is based upon and claims the benefit of priority from the prior Japanese Patent Application No. 2023-187753, filed Nov. 1, 2023, the entire contents of which are incorporated herein by reference.

### BACKGROUND OF THE INVENTION

The present disclosure relates to an encryption device, an encryption method, and an encryption program for encrypting a targeted model, as well as an optimization system.

Ising machines based on quantum annealing or simulated annealing are often used in the form of cloud computing. In such cases, it is theoretically possible for the provider of the Ising machine to eavesdrop on the information of the combinatorial optimization problems used by the users of the cloud machine.

It is undesirable for the information of the combinatorial optimization problems to be leaked. Therefore, it is desirable to perform encryption such that even if the information sent to the Ising machine is eavesdropped, it would be difficult to ascertain what optimization problem is being solved.

For example, Non-Patent Literature 1 proposes a method of encrypting an Ising model input to the Ising machine by randomly reversing the signs of the variables used in the Ising model as a technique related to encryption.

Furthermore, Non-Patent Literature 2 describes redundancy of qubits.

### PRIOR ART DOCUMENTS

Non-Patent Literature 1: D. O'Malley and J. K. Golden, “Homomorphic Encryption for Quantum Annealing with Spin Reversal Transformations,” 2020 IEEE High-Performance Extreme Computing Conference (HPEC), Waltham, MA, USA, 2020, doi: 10.1109/HPEC43674.2020.9286176.
Non-Patent Literature 2: K. L. Pudenz, T. Albash, and D. A. Lidar. “Error-corrected quantum annealing with hundreds of qubits,” Nature communications 5.1, 2014

### SUMMARY OF THE INVENTION

The encryption method described in Non-Patent Literature 1 only changes the signs of the variables, making it highly likely that constraints, etc., can be inferred, and it cannot be said that sufficient encryption is achieved.

Therefore, it is an exemplary object of the present disclosure to provide an encryption device, an encryption method, and an encryption program that can encrypt the original model content to make it difficult to infer, as well as an optimization system that uses this encryption device.

The encryption device according to the present disclosure includes a model input means for receiving input of a model represented by a Hamiltonian, and a model rewriting means for generating a rewritten model by rewriting one variable selected from the variables included in the model into multiple dummy variables subject to a same value constraint, wherein the model rewriting means generates the rewritten model such that sum of coefficients of the dummy variables equals a coefficient of the one variable.

The optimization system according to the present disclosure includes an Ising machine that executes optimization processing of a model represented by a Hamiltonian, and an encryption device that sends the model to the Ising machine, and has the Ising machine execute optimization processing, wherein the encryption device includes a model input means for receiving input of a model represented by a Hamiltonian, a model rewriting means for generating a rewritten model by rewriting one variable selected from the variables included in the model into multiple dummy variables subject to a same value constraint, and an execution means for having the Ising machine execute optimization processing of the rewritten model, wherein the model rewriting means generates the rewritten model such that sum of coefficients of the dummy variables equals a coefficient of the one variable.

The encryption method by a computer according to the present disclosure comprising: receiving input of a model represented by a Hamiltonian; generating a rewritten model by rewriting one variable selected from variables included in the model into multiple dummy variables subject to a same value constraint; and generating the rewritten model such that sum of coefficients of the dummy variables equals a coefficient of the one variable.

The optimization program according to the present disclosure for causing a computer to execute: a model input process that receives input of a model represented by a Hamiltonian; and a model rewriting process that generates a rewritten model by rewriting one variable selected from the variables included in the model into multiple dummy variables subject to a same value constraint, wherein, in the model rewriting process, the rewritten model is generated such that sum of coefficients of the dummy variables equals a coefficient of the one variable.

According to the present disclosure, it is possible to encrypt the original model content to make it difficult to infer.

### BRIEF DESCRIPTION OF DRAWINGS

FIG. 1 is an explanatory diagram showing a configuration example of one example embodiment of the encryption device according to the present disclosure.

FIG. 2A is an explanatory diagram showing an example of a graph.

FIG. 2B is an explanatory diagram showing another example of a graph.

FIG. 3 is an explanatory diagram showing an example of a matrix.

FIG. 4 is an explanatory diagram showing another example of a matrix.

FIG. 5 is an explanatory diagram showing an example of the graph structure of a complete bipartite graph.

FIG. 6 is an explanatory diagram showing an example of a QUBO matrix.

FIG. 7 is a flowchart showing an example of the operation of the encryption device.

FIG. 8 is a block diagram showing an overview of the encryption device according to the present disclosure.

FIG. 9 is a block diagram showing an overview of the optimization system according to the present disclosure.

### DETAILED DESCRIPTION OF THE INVENTION

Hereinafter, example embodiments of the present disclosure will be described with reference to the drawings.

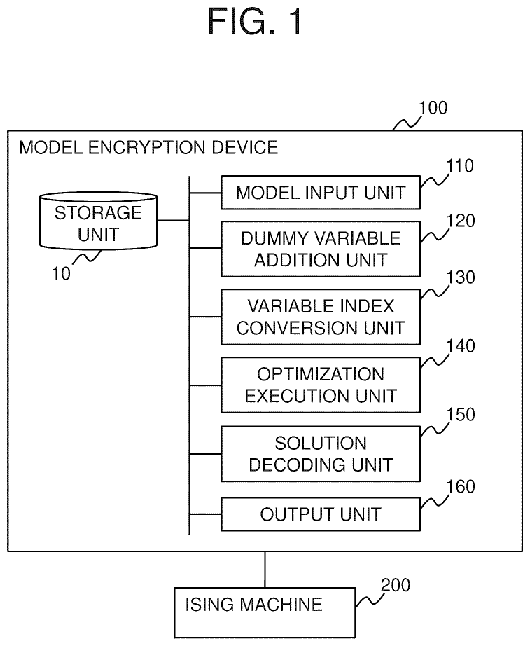

FIG. 1 is an explanatory diagram showing a configuration example of one example embodiment of the encryption device according to the present disclosure. The model encryption device 100 of this example embodiment includes a storage unit 10, a model input unit 110, a dummy variable addition unit 120, a variable index conversion unit 130, an optimization execution unit 140, a solution decoding unit 150, and an output unit 160. The model encryption device 100 is connected to an Ising machine 200 that computes an Ising model or QUBO (Quadratic Unconstrained Binary Optimization).

In this example embodiment, the model encrypted by the model encryption device 100 is sent to the Ising machine 200 for optimization processing, so the system including the model encryption device 100 and the Ising machine 200 can be referred to as an optimization system.

The storage unit 10 stores various types of information used by the model encryption device 100 of this example embodiment. The storage unit 10 may store the model received by the model input unit 110 described below or the model converted by the dummy variable addition unit 120. The storage unit 10 may be realized by a magnetic disk or the like.

The Ising machine 200 is a computer specialized in solving combinatorial optimization problems approximately by inputting them as Ising models or QUBOs, and may be based on quantum annealing or simulated annealing. Specifically, the Ising machine 200 is a dedicated device for finding the ground state of the Hamiltonian of an Ising model or QUBO, and is a device that performs solving based on the Ising model or QUBO. More specifically, the Ising machine 200 is a device that probabilistically finds the values of binary variables that minimize or maximize the objective function (i.e., Hamiltonian) of the Ising model or QUBO, which uses binary variables as arguments. The binary variables may be realized by classical bits or qubits.

In the case of an Ising machine based on quantum annealing, elements or devices utilizing quantum mechanical properties are used. These quantum mechanical properties are very susceptible to external noise and internal noise of the device, and error correction technology for the elements themselves is still under development. Therefore, when inputting a combinatorial optimization problem to the hardware, ingenuity is required to make the most of the quantum mechanical features.

One such method is the redundancy of qubits discussed in Non-Patent Literature 2 mentioned above. One method of redundancy is to represent the variables of a combinatorial optimization problem not with a single qubit, but with multiple qubits that serve the same role. These multiple bits that serve the same role are called “chains.” The interaction terms in the Hamiltonian are set so that the qubits within a single chain take the same value in the optimal solution.

The model input unit 110 receives input of an Ising model or QUBO (hereinafter, these two may be collectively referred to simply as “model” or “model represented by Hamiltonian”). The Ising model and QUBO are represented, for example, by matrices or arrays of coefficients.

The dummy variable addition unit 120 adds a variable that is subject to a constraint to have the same value as one variable selected from the variables included in the Ising model or QUBO (hereafter referred to as a dummy variable). In other words, the dummy variable addition unit 120 generates a model (hereinafter, it may also be referred to as “rewritten model”) by rewriting one variable selected from the variables included in the Ising model or QUBO into multiple variables (i.e., multiple dummy variables) subject to a same value constraint. The rewritten model may include constraint conditions that the variables must satisfy.

The selected one variable may be a single variable or multiple variables. The method of selecting one variable is not particularly limited; the system may arbitrarily decide, or the user may explicitly select it in consideration of the characteristics of the Ising machine 200. Also, the number of dummy variables to rewrite is not particularly limited. The dummy variable addition unit 120 may determine the number of dummy variables within the range in which variables can be assigned to qubits, for example.

Furthermore, the dummy variable addition unit 120 sets the coefficients of the dummy variables so that the sum of the coefficients of the dummy variables equals the coefficient of the one variable (original variable). The coefficients assigned to each dummy variable may be arbitrary as long as the sum equals the coefficient of the one variable.

For example, if the range of coefficients suitable for processing by the Ising machine 200 is known, it is preferable to specify this range in advance. In this case, the dummy variable addition unit 120 may prioritize setting the values of the dummy variables' coefficients within the predefined range. Suitable examples include cases where the processing result has less noise, processing is faster, etc.

Moreover, as a criterion for determining suitability, the dummy variable addition unit 120 may set the coefficients in consideration of the characteristics of the Ising machine 200 (e.g., quantum annealing machine). Characteristics of the Ising machine 200 include, for example, the graph structure related to the connections between qubits and the accuracy of the operation of each qubit. For example, if it is known that the performance of a qubit cannot be fully utilized unless the numerical values of the weight hᵢ or interaction Jᵢⱼ assigned to a variable xᵢ fall within a certain range, the coefficients may be set so that the numerical values fall within that range. Specific examples of setting coefficients in consideration of the characteristics of the Ising machine 200 (e.g., quantum annealing machine) will be described later.

The following describes specific examples of adding dummy variables. First, the case of QUBO is illustrated. In QUBO, for example, it is assumed that there is a term in the Hamiltonian that includes a binary variable xᵢ∈{0,1} as illustrated in the following Equation 1.

$$\begin{matrix}[ Math . 1 ] & \\ {Q}_{i , i} {x}_{i} {x}_{i} + {\sum }_{j < i} {Q}_{j , i} {x}_{j} {x}_{í} + {\sum }_{i < j} {Q}_{i , j} {x}_{i} {x}_{j} & ( Equation 1 )\end{matrix}$$

The dummy variable addition unit 120 generates a model as illustrated in the following Equation 2, where the variable xᵢ is rewritten into K binary variables x_{(i,k)} (0≤k≤K−1) as dummy variables. Here, C is a hyperparameter.

$$\begin{matrix}[ Math . 2 ] & \\ {\sum }_{k = 0}^{K - 1} {Q}_{( i , k ) , ( i , k )} {x}_{( i , k )} {x}_{( i , k )} + {\sum }_{j < i} ( {\sum }_{k = 0}^{K - 1} {Q}_{j , ( i , k )} {x}_{j} {x}_{( i , k )} ) + {\sum }_{i < j} ( {\sum }_{k = 0}^{K - 1} {Q}_{( i , k ) , j} {x}_{( i , k )} {x}_{j} ) + C {\sum }_{( k , l ) ∈ E} {( {x}_{( i , k )} - {x}_{( i , l )} )}^{2} & ( Equation 2 )\end{matrix}$$

At this time, the dummy variable addition unit 120 sets the coefficients of each dummy variable such that the sum of the coefficients equals the coefficient of the one variable xᵢ. In other words, the following relationship illustrated in Equation 3 holds.

$$\begin{matrix}[ Math . 3 ] & \\ {\sum }_{k = 0}^{K - 1} {Q}_{( i , k ) , ( i , k )} = {Q}_{i , i} , {\sum }_{k = 0}^{K - 1} {Q}_{j , ( i , k )} = {Q}_{j , i} , {\sum }_{k = 0}^{K - 1} {Q}_{( i , k ) , j} = {Q}_{i , j} & ( Equation 3 )\end{matrix}$$

In addition, the dummy variable addition unit 120 sets conditions so that the following relationship illustrated in Equation 4 holds for all k (0≤k≤K−1). The conditions shown in Equation 4 indicate the condition to prevent the change of sign of the coefficients. In other words, the dummy variable addition unit 120 generates a model (rewritten model) including conditions indicating a constraint that the sign of a dummy variable should not be changed to the sign of an original variable.

$$[ Math . 4 ]$$

$$sgn ( {Q}_{( i , k ) . ( i , k )} ) ∈ \{ sgn ( {Q}_{i , i} ) , 0 \} , sgn ( {Q}_{j , ( ik )} ) ∈ \{ sgn ( {Q}_{j i} ) , 0 \} , sgn ( {Q}_{( i , k ) , j} ) ∈ \{ sgn ( {Q}_{i , j} ) , 0 \} \qquad ( Equation 4 )$$

Here, sgn(x) is the sign function, and it has the following properties.

$$sgn ( x ) = + 1 ( x > 0 ) , 0 ( x = 0 ) , - 1 ( x < 0 ) \qquad [ Math . 5 ]$$

Moreover, the last term in Equation 2 represents the constraint that multiple dummy variables rewritten for one variable all have the same value. And, the E included in the last term represents a set of edges of a connected graph G(V,E) having all of x(i,k) as vertices for the index i of the variable under consideration. A connected graph is a graph in which any two selected vertices can be connected by traversing the edges of the graph. Here, two connected variables indicate that they take the same value.

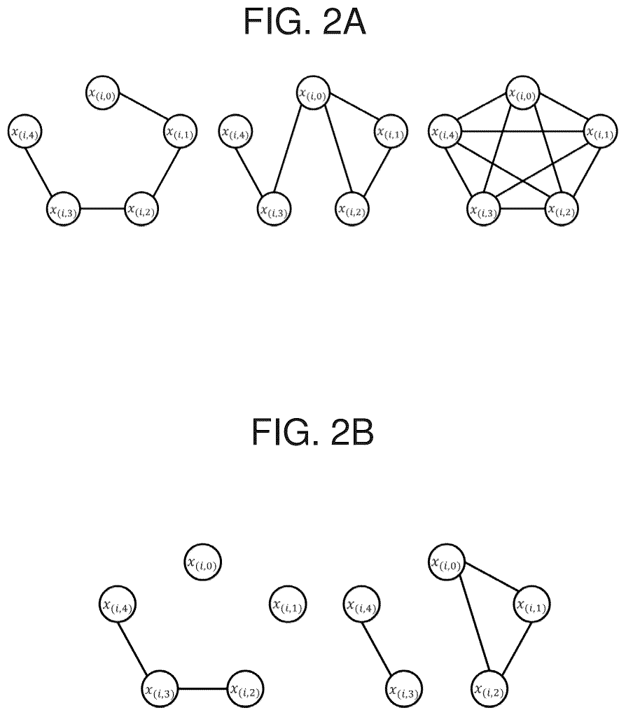

FIG. 2A and FIG. 2B are explanatory diagrams showing examples of graphs. For example, it is assumed that there are five dummy variables x_{(i,0)}, x_{(i,1)}, x_{(i,2)}, x_{(i,3)}, and x_{(i,4)}. FIG. 2A shows an example of a connected graph representing the interaction between the dummy variables when there are five dummy variables. On the other hand, FIG. 2B shows an example of a graph that is not a connected graph representing the interaction between the dummy variables when there are five dummy variables.

As described above, the multiple dummy variables rewritten from one variable must all take the same value. When the properties of the connected graph described above are satisfied by each variable, the fact that the connected variables take the same value ensures that all the variables ultimately take the same value.

Therefore, the dummy variable addition unit 120 generates a model (rewritten model) by adding a term representing the constraint that the variables indicated by the nodes connected by edges take the same value if the graph formed by treating each dummy variable as a node and connecting nodes with interactions by edges is a connected graph.

Next, the case of the Ising model is illustrated. In the Ising model, for example, it is assumed that there is a term in the Hamiltonian that includes a spin variable σᵢ∈{+1, −1} as illustrated in the following Equation 5.

$$[ Math . 6 ]$$

$$- {\sum }_{j < i} {J}_{j , \dot{ι}} {σ}_{j} {σ}_{i} - {\sum }_{i < 1} {J}_{i , j} {σ}_{i} {σ}_{J} - {h}_{i} {σ}_{i} \qquad ( Equation 5 )$$

The dummy variable addition unit 120 generates a model as illustrated in the following Equation 6, where the variable σᵢ is rewritten into K spin variables σ_{(i,k)} (0≤k≤K−1) as dummy variables.

$$[ Math . 7 ]$$

$$- {\sum }_{j < i} ( {\sum }_{k = 0}^{K - 1} {J}_{j , ( i , k )} {σ}_{j} {σ}_{( i , k )} ) - {\sum }_{i < j} ( {\sum }_{k = 0}^{K - 1} {J}_{( i , k ) , j} {σ}_{( i , k )} {σ}_{j} ) - {{\sum }_{k = 0}}^{K - 1} {h}_{( i , k )} {σ}_{( i , k )} + C {\sum }_{( k , l ) ∈ E} {( {σ}_{( i , k )} - {σ}_{( i , l )} )}^{2} \qquad ( Equation 6 )$$

Here, the sum of the coefficients of the dummy variables σ_{(i,k)} equals the coefficient of the one variable (original variable) σᵢ. In other words, the following relationship illustrated in Equation 7 holds.

$$[ Math . 8 ]$$

$${\sum }_{k = 0}^{K - 1} {J}_{j , ( i , k )} = {J}_{j , i} , {\sum }_{k = 0}^{K - 1} {J}_{( i , k ) , j} = {J}_{i , j} , {\sum }_{k = 0}^{K - 1} {h}_{( i , k )} = {h}_{i} \qquad ( Equation 7 )$$

In addition, the following relationship illustrated in Equation 8 holds for all k (0≤k≤K−1).

$$[ Math . 9 ]$$

$$sgn ( {J}_{j ( i , k )} ) ∈ \{ sgn ( {J}_{j , i} ) , 0 \} , sgn ( {J}_{( i , k ) , j} ) ∈ \{ sgn ( {J}_{i , j} ) , 0 \} , sgn ( {h}_{( i , k )} ) ∈ \{ sgn ( {h}_{i} ) , 0 \} \qquad ( Equation 8 )$$

Here, the Ising model and QUBO can be converted using the relationship between variables σᵢ=1−2xᵢ. Therefore, the dummy variable addition unit 120 may convert the Ising model into QUBO, or vice versa, before rewriting the coefficients, and then return it to the original model.

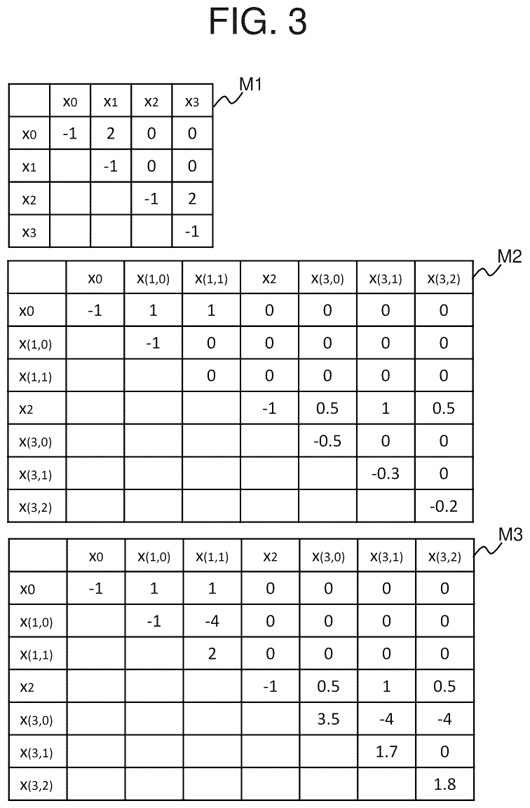

Next, the process of the dummy variable addition unit 120 is described in detail using a specific example. FIG. 3 is an explanatory diagram showing an example of a matrix used in this specific example. In this specific example, a QUBO represented by the Hamiltonian of Equation 9 is illustrated. Note that due to the nature of binary variables, xᵢ²=xᵢ holds.

$$[ Math . 10 ]$$

$${( {x}_{0} + {x}_{1} - 1 )}^{2} + {( {x}_{2} + {x}_{3} - 1 )}^{2} = - {x}_{0}^{2} - {x}_{1}^{2} + 2 {x}_{0} {x}_{1} - {x}_{2}^{2} - {x}_{3}^{2} + 2 {x}_{2} {x}_{3} + 2 \qquad ( Equation 9 )$$

The QUBO matrix representing this QUBO is expressed as the matrix M1 in FIG. 3. In Equation 9, there are four types of variables x₀, x₁, x₂, x₃. In this specific example, it is assumed that x₁ and x₃ are selected as the variables to be rewritten. Also, for each variable, suppose x1 is rewritten into x(1,0) and x_{(1,1)}, and x₃ is rewritten into x_{(3,0)}, x_{(3,1)}, and x_{(3,2)}.

At this time, the terms included in Equation 9 are rewritten as illustrated below. The QUBO matrix in this case is expressed as the matrix M2 in FIG. 3.

$$\begin{matrix}- {x}_{1}^{2} + 2 {x}_{{0}^{{x}_{1}}} \to - {x}_{( 1 , 0 )}^{2} + 0 \cdot {x}_{( 1 , 1 )}^{2} + {x}_{0} {x}_{( 1 , 0 )} + {x}_{0} {x}_{( 1 , 1 )} \\ - {x}_{3}^{2} + 2 {x}_{2} {x}_{3} \to - 0.5 {x}_{( 3 , 0 )}^{2} - 0.3 {x}_{( 3 , 1 )}^{2} - 0.2 {x}_{( 3 , 2 )}^{2} + 0.5 {x}_{2} {x}_{( 3 , 0 )} + {x}_{2} {x}_{( 3 , 1 )} + 0.5 {x}_{2} {x}_{( 3 , 2 )}\end{matrix} \qquad \begin{matrix}[ Math . 11 ] & \end{matrix}$$

When solving the QUBO, it is necessary that x=x_{(1,0)}=x_{(1,1)} and x₃=x_{(3,0)}=x_{(3,1)}=x_{(3,2)} hold. To satisfy this relationship, the following Equation 10 is added to the Hamiltonian. When such a formula is a added, the QUBO matrix is expressed as matrix M3 in FIG. 3.

$$[ Math . 12 ]$$

$$\begin{matrix}2 {( {x}_{( 1 , 0 )} - {x}_{( 1 , 1 )} )}^{2} = 2 {x}_{( 1 , 0 )}^{2} - 4 {x}_{( 1 , 0 )} {x}_{( 1 , 1 )} + 2 {x}_{( 1 , 1 )}^{2} \\ 2 {( {x}_{( 3 , 0 )} - {x}_{( 31 )} )}^{2} = 2 {x}_{( 3 , 0 )}^{2} - 4 {x}_{( 3 , 0 )} {x}_{( 3 , 1 )} + 2 {x}_{( 3 , 1 )}^{2} \\ 2 {( {x}_{( 3 , 0 )} - {x}_{( 3 , 2 )} )}^{2} = 2 {x}_{( 3 , 0 )}^{2} - 4 {x}_{( 3 , 0 )} {x}_{( 3 , 2 )} + 2 {x}_{( 3 , 2 )}^{2}\end{matrix} \qquad ( Equation 10 )$$

When the QUBO matrix represented by the matrix M3 is solved by the Ising machine 200, one of the following solutions is obtained.

$$[ Math . 13 ]$$

$${x}_{0} = {x}_{2} = 1 , {x}_{( 1 , 0 )} = {x}_{( 1 , 1 )} = {x}_{( 3 , 0 )} = {x}_{( 3 , 1 )} = {x}_{( 3 , 2 )} = 0 \qquad ( 1 )$$

$${x}_{( 1 , 0 )} = {x}_{( 1 , 1 )} = {x}_{2} = 1 , {x}_{0} = {x}_{( 3 , 0 )} = {x}_{( 3 , 1 )} = {x}_{( 3 , 2 )} = 0 \qquad ( 2 )$$

$${x}_{0} = {x}_{( 3 , 0 )} = {x}_{( 3 , 1 )} = {x}_{( 3 , 2 )} = 1 , {x}_{( 1 , 0 )} = {x}_{( 1 , 1 )} = {x}_{2} = 0 \qquad ( 3 )$$

$${x}_{( 1 , 0 )} = {x}_{( 1 , 1 )} = {x}_{( 3 , 0 )} = {x}_{( 3 , 1 )} = {x}_{( 3 , 2 )} = 1 , {x}_{0} = {x}_{2} = 0 \qquad ( 4 )$$

In this specific example, assuming that x₁=x_{(1,0)}=x_{(1,1)} and x₃=x_{(3,0)}=x_{(3,1)}=x_{(3,2)}, the solutions of the original combinatorial optimization problem can be interpreted as follows.

$${x}_{0} = {x}_{2} = 1 , {x}_{1} = {x}_{3} = 0 \qquad ( 1 )$$

$${x}_{1} = {x}_{2} = 1 , {x}_{0} = {x}_{3} = 0 \qquad ( 2 )$$

$${x}_{0} = {x}_{3} = 1 , {x}_{1} = {x}_{2} = 0 \qquad ( 3 )$$

$${x}_{1} = {x}_{3} = 1 , {x}_{0} = {x}_{2} = 0 \qquad ( 4 )$$

The variable index conversion unit 130 converts the indexes of variables. The variable index conversion unit 130, for example, converts the indexes of variables by mutually replacing the indexes of the variables included in the model. By performing such conversions, it is possible to make the contents of the input model more difficult to understand. If the variable indexes are not converted, the model encryption device 100 may not include the variable index conversion unit 130.

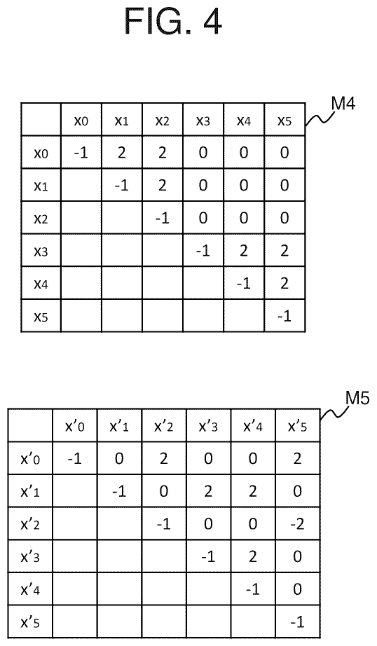

The following describes a specific example of the process of converting variable indexes. FIG. 4 is an explanatory diagram showing an example of a matrix used in this specific example. For example, if the Hamiltonian represented by the following Equation 11 is represented by a QUBO matrix, it is expressed as the matrix M4 in FIG. 4.

$$[ Math . 15 ]$$

$${( {x}_{0} + {x}_{1} + {x}_{2} - 1 )}^{2} + {( {x}_{3} + {x}_{4} + {x}_{5} - 1 )}^{2} \qquad ( Equation 11 )$$

Here, it is assumed that the variable indexes are rewritten as follows. The indexes must be associated so that they do not overlap when rewriting.
x₀→x′₂, x₁→x′₅, x₂→x′₀, x₃→x′₁, x₄→x′₄, x₅→x′₃ In this case, Equation 11 illustrated above is rewritten as Equation 12 below.

$$[ Math . 16 ]$$

$${( {x}_{2}^{′} + {x}_{5}^{′} + {x}_{0}^{′} - 1 )}^{2} + {( {x}_{1}^{′} + {x}_{4}^{′} + {x}_{3}^{′} - 1 )}^{2} \qquad ( Equation 12 )$$

And, the Hamiltonian of Equation 12 is represented by a QUBO matrix as matrix M5 in FIG. 4. Thus, the transformation in this example embodiment can be referred to as rearrangement of indexes.

Note that the method of converting the indexes of variables is not limited to the rearrangement of indexes described above. The variable index conversion unit 130 may rewrite the QUBO matrix using methods such as the “homomorphic encryption” described in Non-Patent Literature 1.

The optimization execution unit 140 sends the rewritten model to the Ising machine 200, and has the Ising machine execute optimization processing. Since the method of solving QUBOs or Ising models in the Ising machine 200 is widely known, detailed explanation is omitted here.

When executing optimization processing in the Ising machine 200, the optimization execution unit 140 may assign variables, among variables included in the rewritten model, with a large number of rewritten dummy variables to less reliable qubits. In other words, the optimization execution unit 140 may assign variables to qubits considering the characteristics of the Ising machine 200 (e.g., quantum annealing machine).

The following describes specific examples of how to set coefficients and assign qubits considering the characteristics of the Ising machine 200. Here, the Hamiltonian of the QUBO model is illustrated by Equation 13 below, assuming that this Hamiltonian is input into a quantum annealing machine with six qubits having the structure of a complete bipartite graph.

$$[ Math . 17 ]$$

$$H = - 3 {x}_{1}^{2} + 5 {x}_{2}^{2} + 12 {x}_{3}^{2} - 6 {x}_{1} {x}_{2} - 12 {x}_{1} {x}_{3} + 4 {x}_{2} {x}_{3} \qquad ( Equation 13 )$$

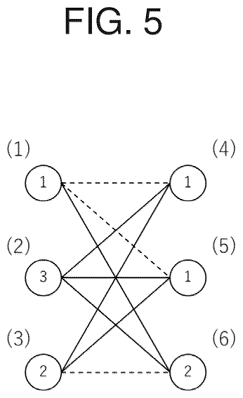

FIG. 5 is an explanatory diagram showing an example of the graph structure of a complete bipartite graph. The example shown in FIG. 5 illustrates a method of assigning a problem consisting of three variables to six qubits having the graph structure of a complete bipartite graph. The dashed lines illustrated in FIG. 5 represent the interactions of the chains, and the solid lines represent the interactions in the Hamiltonian. The numbers within the nodes represent the indexes of the variables in the Hamiltonian of the problem to be solved, and the numbers in parentheses represent the indexes of the variables in the Hamiltonian to be solved by the quantum annealing machine.

Specifically, the indexes of the variables x₁, x₂, x₃ represented by the Hamiltonian illustrated by Equation 13 correspond to the numbers within the nodes in FIG. 5. Moreover, the variables x₁, x₂, x₃ are each represented by three, two, and one qubits, respectively. These multiple different qubit groups corresponding to a single variable are referred to as chains, as described above.

The dummy variable addition unit 120 may determine the number of qubits included in the chain corresponding to the same variable based on whether there are many high-performance qubits that operate as expected, considering the characteristics of the quantum annealing machine.

For example, it is assumed that among the qubits illustrated in FIG. 5, qubit (2) has the highest performance, qubits (3) and (6) have moderate performance, and qubits (1), (4), and (5) have lower performance than moderate. In this case, the dummy variable addition unit 120 may represent the variable with only the high-performance qubit (2). The dummy variable addition unit 120 may then create chains with more qubits as performance decreases, representing the variables with chains including qubits (3) and (6) and with chains including qubits (1), (4), and (5).

In this case, although the variables x₁, x₂ are represented by multiple different qubits in the quantum annealing machine, the result calculated by the quantum annealing machine should be the same for the qubits corresponding to each variable. Therefore, the dummy variable addition unit 120 adds a term representing the interaction within the chain such that the qubits corresponding to the variables x₁, x₂ take the same value.

In other words, in the quantum annealing machine, the interaction of the chain ensures that the qubits corresponding to the same variable in the original Hamiltonian represented by Equation 13 take the same value. Regarding this, for qubits (i) and (j) that should have the same value, the quantum annealing machine is caused to solve the problem by adding the Hamiltonian illustrated in the following Equation 14.

$$[ Math . 18 ]$$

$${( {x}_{( i )} - {x}_{( j )} )}^{2} = {x}_{( i )}^{2} + {x}_{( j )}^{2} - 2 {x}_{( i )} {x}_{( j )} \qquad ( Equation 14 )$$

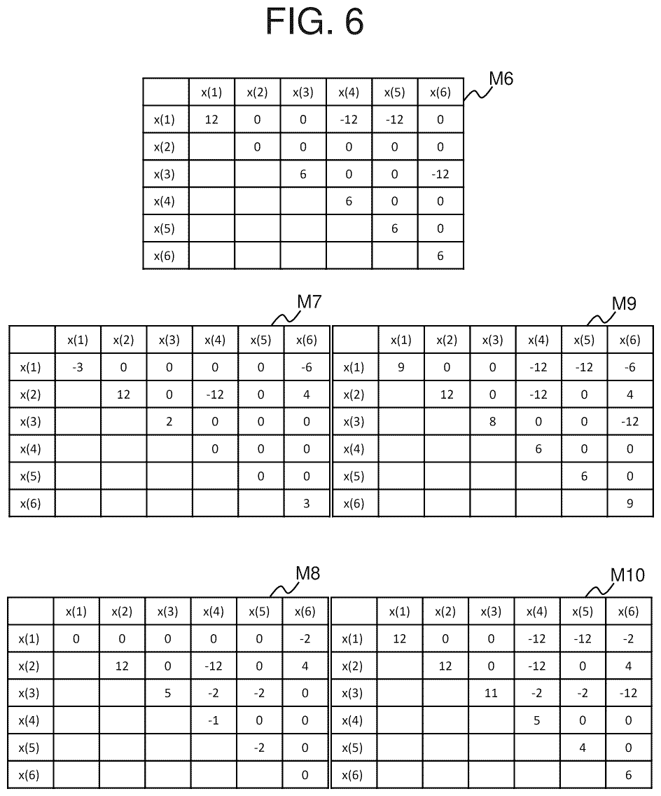

FIG. 6 is an explanatory diagram showing an example of a QUBO matrix used in the graph structure of a complete bipartite graph. When solving the Hamiltonian represented by Equation 13 in the graph structure illustrated in FIG. 5, the interaction introduced is expressed by the matrix M6 in FIG. 6. However, the chain interaction is scaled by a constant so that the constraint condition represented by the interaction is satisfied.

When solving the QUBO matrix of Equation 13 illustrated above using a quantum annealing machine with the graph structure illustrated in FIG. 5, the dummy variable addition unit 120 may rewrite the QUBO matrix into the matrix M7 or M8 in FIG. 6. The QUBO matrix with the chain interaction added to the Hamiltonian to be solved by the quantum annealing machine is expressed as matrix M9 or matrix M10 in FIG. 6.

Here, matrix M9 in FIG. 6 is set so that the absolute value of the components is as close to six or more as possible when the maximum value is set to twelve. Similarly, matrix M10 in FIG. 6 is set so that the absolute value of the components is as close to twelve and below six as possible.

It is assumed that the quantum annealing machine used has the characteristic that its performance is better when the absolute values of the components of the QUBO matrix are closer. In this case, it is preferable to input a QUBO matrix like matrix M9. On the other hand, it is assumed that the quantum annealing machine used has the characteristic that its performance is better when more components of the QUBO matrix are close to zero. In this case, it is preferable to input a QUBO matrix like matrix M10.

In this way, when the dummy variable addition unit 120 adds dummy variables in this example embodiment, it is possible to actively apply the redundancy of the chain, making it possible to set problems that match the characteristics of the quantum annealing machine.

The solution decoding unit 150 decodes the calculation result of the Ising machine, which has solved the model converted by the dummy variable addition unit 120 and the variable index conversion unit 130, back into the pre-conversion result. In other words, the solution decoding unit 150 decodes from the dummy variables back to the original variables.

Due to the nature of the Ising machine, noise may occur in qubits, and it is assumed that not all dummy variables will match. In this case, the solution decoding unit 150 may decode the most frequent variable (i.e., majority rule) among the dummy variables as the original variable.

The output unit 160 outputs the decoded variables (i.e., returned to the pre-conversion result).

The model input unit 110, the dummy variable addition unit 120, the variable index conversion unit 130, the optimization execution unit 140, the solution decoding unit 150, and the output unit 160 are realized by a computer processor (e.g., CPU (Central Processing Unit), GPU (Graphics Processing Unit)) that operates according to a program (encryption program). For example, the program may be stored in the storage unit 10 of the model encryption device 100, and the processor may read the program and operate as the model input unit 110, the dummy variable addition unit 120, the variable index conversion unit 130, the optimization execution unit 140, the solution decoding unit 150, and the output unit 160 in accordance with the program.

Moreover, the functions of the model input unit 110, the dummy variable addition unit 120, the variable index conversion unit 130, the optimization execution unit 140, the solution decoding unit 150, and the output unit 160 may be provided in the form of SaaS (Software as a Service). Alternatively, each of the model input unit 110, the dummy variable addition unit 120, the variable index conversion unit 130, the optimization execution unit 140, the solution decoding unit 150, and the output unit 160 may be realized by dedicated hardware.

Furthermore, some or all of the components of each device may be realized by general-purpose or dedicated circuits, processors, etc., or combinations thereof. These may be configured by a single chip or by multiple chips connected via a bus. Some or all of the components of each device may be realized by combinations of the above-mentioned circuits, etc., and a program.

In addition, if some or all of the components of the model input unit 110, the dummy variable addition unit 120, the variable index conversion unit 130, the optimization execution unit 140, the solution decoding unit 150, and the output unit 160 are realized by multiple information processing devices or circuits, the multiple information processing devices or circuits may be centrally located or distributed. For example, the information processing devices or circuits may be realized in the form of a client-server system, cloud computing system, etc., where each is connected via a communication network.

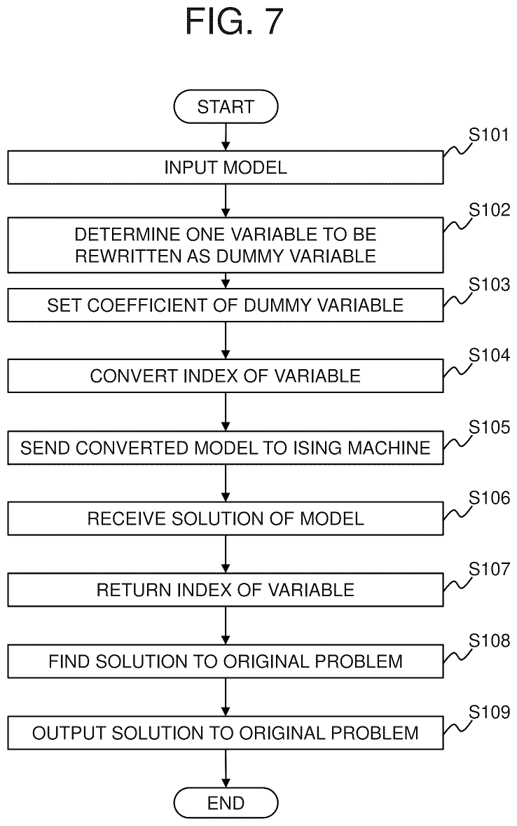

Next, an example of the operation of the model encryption device 100 of this example embodiment will be described. FIG. 7 is a flowchart showing an example of the operation of the model encryption device 100 of this example embodiment.

The model input unit 110 inputs an Ising model or QUBO as a matrix or array of coefficients (Step S101). The dummy variable addition unit 120 randomly determines one variable to be rewritten as a dummy variable from among variables included in the input Ising model or QUBO (step S102). At this time, the number of variables to be rewritten as dummy variables among the variables, the number of dummy variables for one variable, and the total number of dummy variables, etc. included in the model may be set by a user or the like.

Furthermore, the dummy variable addition unit 120 sets the coefficients of the dummy variables such that, for the dummy variable to be rewritten, the sum of the coefficients of the dummy variables equals the coefficient of the one variable when the model is solved by the Ising machine 200 (Step S103). At this time, the dummy variable addition unit 120 (or the storage unit 10) retains information about the dummy variables and the set coefficients.

Next, the variable index conversion unit 130 converts the indexes of the variables, including the dummy variables, included in the model (Step S104). At this time, the variable index conversion unit 130 (or the storage unit 10) retains the information about the rearranged indexes.

The optimization execution unit 140 sends the QUBO or Ising model obtained from the variable index conversion unit 130 (i.e., the converted model) to the Ising machine 200 (Step S105) and has it execute optimization processing. After that, the solution decoding unit 150 receives the solution of the QUBO or Ising model sent by the Ising machine 200 (Step S106).

The solution decoding unit 150 returns the indexes of the variables to the indexes at the time of step S103, based on the information on rearrangement of the held indexes (Step S107). Furthermore, the solution decoding unit 150 determines the value of each variable based on the value of the variable whose index has been returned and the information on the dummy variables retained, and finds the solution to the original problem (Step S108). The output unit 160 then outputs the solution to the original problem obtained in Step S108 (Step S109).

As described above, in this example embodiment, the model input unit 110 receives input of a model represented by a Hamiltonian, the dummy variable addition unit 120 generates a rewritten model by rewriting one variable selected from the variables included in the model into multiple dummy variables subject to the same value constraint. At this time, the dummy variable addition unit 120 generates the rewritten model such that sum of coefficients of the dummy variables equals a coefficient of the one variable. Therefore, the original model content can be encrypted to make it difficult to infer.

For example, even if the Ising model or QUBO input to the Ising machine is eavesdropped, it can prevent the combinatorial optimization problem being solved from being understood.

In other words, it is possible for the provider of the computing environment to eavesdrop on the input model. However, in this example embodiment, the dummy variable addition unit 120 rewrites one variable into dummy variables. Therefore, users of Ising machines, such as quantum annealing machines, which are commonly used in the cloud, will also be able to use Ising machines with confidence.

Furthermore, in this example embodiment, the dummy variable addition unit 120 rewrites one variable into multiple dummy variables subject to the same value constraint, so it is also possible to implement error countermeasures while encrypting. Moreover, in this example embodiment, encryption can be performed without wasting the number of qubits for quantum annealing, which is limited in the number of qubits. Therefore, there is an advantage when using a quantum annealing machine as the Ising machine.

For example, the method described in Non-Patent Literature 1 does not assume the increase of variables, so it is not possible to set appropriate chains when using a quantum annealing machine. Furthermore, when calculating with an Ising machine, it is known that the number of variables becomes the square of an integer (4, 9, 16, . . . ) when the input model takes specific constraints. Conversely, if the number of variables is represented by the square of an integer, it can be said that the problem is likely to take those constraint conditions. In the method described in Non-Patent Literature 1, the number of variables is not changed, so there is a possibility of obtaining information about the constraint conditions based on the number of variables. On the other hand, in this example embodiment, the dummy variable addition unit 120 changes the number of variables, making it possible to hide information about the constraint conditions.

Moreover, when calculating with an Ising machine, if the input model takes specific constraints, 2-3 types of coefficients may frequently appear. The method described in Non-Patent Literature 1 does not change the absolute value of the input model, so there is a possibility that the constraint conditions can be inferred from the absolute value of the coefficients. On the other hand, in this example embodiment, the dummy variable addition unit 120 changes the values of the coefficients, making it possible to hide information about the constraint conditions.

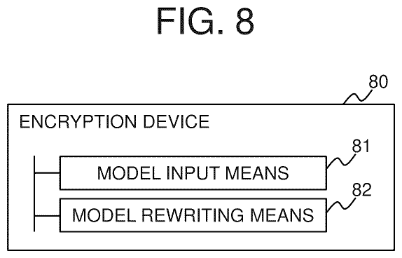

Next, an overview of the present disclosure is described. FIG. 8 is a block diagram showing an overview of the encryption device according to the present disclosure. The encryption device 80 (e.g., model encryption device 100) according to the present disclosure includes a model input means 81 (e.g., model input unit 110) for receiving input of a model (e.g., Ising model or QUBO) represented by a Hamiltonian, and a model rewriting means 82 (e.g., dummy variable addition unit 120) for generating a rewritten model by rewriting one variable selected from variables included in the model into multiple dummy variables subject to a same value constraint.

The model rewriting means 82 generates the rewritten model such that sum of the coefficients of the dummy variables equals a coefficient of the one variable.

With such a configuration, the original model content can be encrypted to make it difficult to infer.

Furthermore, the model rewriting means 82 may generate the rewritten model that includes a constraint preventing signs of the dummy variables from changing from the sign of the one variable.

Moreover, the model rewriting means 82 may generate the rewritten model by adding a term representing a constraint that the variables indicated by nodes connected by edges take the same value if a graph formed by treating each dummy variable as a node and connecting nodes with interactions by edges is a connected graph.

In addition, the model rewriting means 82 may set values of the coefficients of the dummy variables within a predefined range.

The encryption device 80 may include an execution means (e.g., optimization execution unit 140) for having an Ising machine (e.g., Ising machine 200) execute optimization processing of the rewritten model. The execution means may assign variables, among variables included in the rewritten model, with a large number of rewritten dummy variables to less reliable qubits.

The encryption device 80 may include a variable index conversion means (e.g., variable index conversion unit 130) for converting indexes of variables included in the input model. The variable index conversion means may convert the indexes of the variables by mutually replacing the indexes of the variables included in the model.

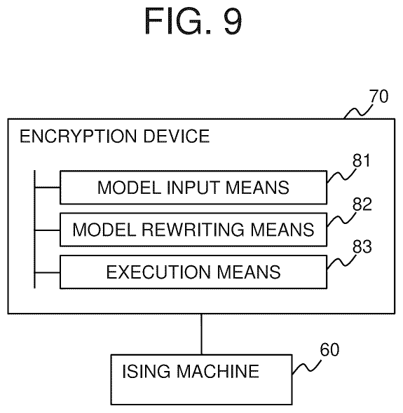

FIG. 9 is a block diagram showing an overview of the optimization system according to the present disclosure. The optimization system 90 (e.g., the system illustrated in FIG. 1) according to the present disclosure includes an Ising machine 60 (e.g., Ising machine 200) that executes optimization processing of a model represented by a Hamiltonian (e.g., Ising model or QUBO) and an encryption device 70 (e.g., model encryption device 100) that sends the model to the Ising machine, and has the Ising machine execute the optimization processing.

The encryption device 70 includes a model input means 81, a model rewriting means 82, and an execution means 83 (e.g., optimization execution unit 140) that has the Ising machine 60 execute optimization processing of the rewritten model. The content of the model input means 81 and the model rewriting means 82 is the same as that of the model input means 81 and the model rewriting means 82 illustrated in FIG. 8.

With such a configuration, it is possible to execute optimization processing using an encrypted model that is difficult to infer its original content.

Although the disclosure has been described above with reference to the example embodiments, the disclosure is not limited to the example embodiments described above. Various changes can be made to the configuration and details of the disclosure that can be understood by those skilled in the art within the scope of this disclosure. And each example embodiment can be combined with other example embodiments as appropriate.
10 Storage unit
100 Model encryption device
110 Model input unit
120 Dummy variable addition unit
130 Variable index conversion unit
140 Optimization execution unit
150 Solution decoding unit
160 Output unit
200 Ising machine

1. An encryption device comprising:
a memory storing instructions; and
one or more processors configured to execute the instructions to:
receive input of a model represented by a Hamiltonian;
generate a rewritten model by rewriting one variable selected from variables included in the model into multiple dummy variables subject to a same value constraint; and
generate the rewritten model such that sum of coefficients of the dummy variables equals a coefficient of the one variable.

2. The encryption device according to claim 1,
wherein the processor is configured to execute the instructions to generate the rewritten model that includes a constraint preventing signs of the dummy variables from changing from the sign of the one variable.

3. The encryption device according to claim 1,
wherein the processor is configured to execute the instructions to generate the rewritten model by adding a term representing a constraint that variables indicated by nodes connected by edges take the same value if a graph formed by treating each dummy variable as a node and connecting nodes with interactions by edges is a connected graph.

4. The encryption device according to claim 1,
wherein the processor is configured to execute the instructions to set values of the coefficients of the dummy variables within a predefined range.

5. The encryption device according to claim 1, wherein the processor is configured to execute the instructions to:
assign variables, among variables included in the rewritten model, with a larger number of rewritten dummy variables to less reliable qubits; and
have an Ising machine execute optimization processing of the rewritten model.

6. The encryption device according to claim 1, wherein the processor is configured to execute the instructions to
convert indexes of the variables by mutually replacing the indexes of the variables included in the input model.

7. An optimization system comprising:
an Ising machine that executes optimization processing of a model represented by a Hamiltonian; and
an encryption device that sends the model to the Ising machine, and has the Ising machine execute optimization processing,
wherein the encryption device comprises:
a memory storing instructions; and
one or more processors configured to execute the instructions to:
receive input of a model represented by a Hamiltonian;
generate a rewritten model by rewriting one variable selected from variables included in the model into multiple dummy variables subject to a same value constraint;
generate the rewritten model such that sum of coefficients of the dummy variables equals a coefficient of the one variable; and
have the Ising machine execute optimization processing of the rewritten model.

8. An encryption method by a computer, comprising:
receiving input of a model represented by a Hamiltonian;
generating a rewritten model by rewriting one variable selected from variables included in the model into multiple dummy variables subject to a same value constraint; and
generating the rewritten model such that sum of coefficients of the dummy variables equals a coefficient of the one variable.
